(19) United States
(12) Patent Application Publication
(10) Pub. No.: US 2002/0101676 A1
(43) Pub. Date: Aug. 1, 2002

(54) Calbration of cartridge library and calibration cartridge therefor

(76) Inventor: John Ellis, Louisville, CO (US)

Correspondence Address: NIXON & VANDERHYE P.C., 8th Floor, 1100 North Glebe Road, Arlington, VA, 22201, US

(21) Appl. No.: 09/770,686

(22) Filed: Jan. 29, 2001

(51) Int. Cl. G11B 19/02

(52) U.S. Cl. 360/69

(57) ABSTRACT

An automated cartridge library has a calibration cartridge which includes a radiation (e.g., optical) source, as well as a frame which accommodates a cartridge-receiving unit and a calibration cartridge storage location. The cartridge-receiving unit can be one or both of a media cartridge storage location (e.g., a cell in a cartridge magazine) and a drive which performs at least one of recording and reproducing operations with respect to media in a media cartridge loaded into the drive. A transport device of the library transports the calibration cartridge between the calibration cartridge storage location and the cartridge-receiving unit. The transport device has a radiation detector which can be aligned with the radiation source of the calibration cartridge when the calibration cartridge is in the cartridge-receiving unit. In operation of the library, the radiation source included in the calibration cartridge is activated. The transport device transports the calibration cartridge from the calibration cartridge storage location to the cartridge-receiving unit. Upon insertion of the calibration cartridge into the calibration cartridge storage location, the transport device is positioned so that the radiation detector carried by the transport device is aligned with radiation emitted from the radiation source of the calibration cartridge. A calibration reference value for the cartridge-receiving unit is determined when the radiation detector is aligned with the radiation source included in the calibration cartridge. The calibration reference value can be, for example, a spatial coordinate of the library.

### BACKGROUND

1. FIELD OF THE INVENTION

The present invention pertains to the storage of information, and particularly to automated cartridge handling systems such as cartridge libraries which store cartridges or cassettes of magnetic tape.

2. RELATED ART AND OTHER CONSIDERATIONS

In the early days of computers, information requiring storage could be transmitted from a computer to a tape drive, whereat the information was magnetically recorded on or read from a large reel of tape. Upon completion of an operation of recording on the tape, for example, the reel would be removed manually from the tape drive and mounted in a rack. Another reel from the rack could then be manually mounted, if necessary, in the drive for either an input (tape reading) or output (recording to tape) operation.

Eventually it became popular to enclose magnetic tape in a cartridge, the cartridge being considerably smaller than the traditional tape reels. While many persons are familiar with tape cartridges of a type which can be loaded into a “tape deck” for reproduction of audio information (e.g., music), it is not as commonly realized that similar cartridges, although of differing sizes, can be used to store such information as computer data. For years now magnetic tape cartridges have proven to be an efficient and effective medium for data storage, including but not limited to computer back-up.

Large computer systems have need to access numerous cartridges. To this end, automated cartridge handling systems or libraries for cartridges have been proposed for making the cartridges automatically available to the computer. Many of these automated libraries resemble juke boxes. Typically, prior art automated cartridge libraries have an array of storage positions for cartridges, one or more tape drives, and some type of automated changer or cartridge engagement/transport mechanism for picking or gripping a cartridge and moving the cartridge between a storage position and the tape drive.

Important to the automation of cartridge libraries as previously known has been the provision of the cartridge changer or cartridge engagement/transport mechanism for picking or gripping a cartridge and moving the cartridge between a storage position and the tape drive. Such rotobic mechanisms, often called a cartridge “picker” or “gripper”, is typically mounted in a library frame in order to introduce and remove cartridges relative to one or more stationary drives. The stationary drive and the picker are mounted to the same basic frame structure of the library, but otherwise are structurally independent.

The following United States patents and patent applications, all commonly assigned herewith and incorporated herein by reference, disclose various configurations of automated cartridge libraries, as well as subcomponents thereof (including cartridge engagement/transport mechanisms, entry/exit ports, and storage racks for housing cartridges):

U.S. Pat. No. 4,984,106 to Herger et al., entitled “CARTRIDGE LIBRARY SYSTEM AND METHOD OF OPERATION THEREOF”.

U.S. Pat. No. 4,972,277 to Sills et al., entitled “CARTRIDGE TRANSPORT ASSEMBLY AND METHOD OF OPERATION THEREOF”.

U.S. Pat. No. 5,059,772 to Younglove, entitled “READING METHOD AND APPARATUS FOR CARTRIDGE LIBRARY”.

U.S. Pat. No. 5,103,986 to Marlowe, entitled “CARTRIDGE RACK”.

U.S. Pat. Nos. 5,237,467 and 5,416,653 to Marlowe, entitled “CARTRIDGE HANDLING APPARATUS AND METHOD WITH MOTION-RESPONSIVE EJECTION”.

U.S Pat. No. 5,498,116 to Woodruff et al., entitled “ENTRY-EXIT PORT FOR CARTRIDGE LIBRARY”.

U.S. Pat. No. 5,487,579 to Woodruff et al., entitled PICKER MECHANISM FOR DATA CARTRIDGES”.

U.S. Pat. No. 5,718,339 to Woodruff et al., entitled “CARTRIDGE RACK AND LIBRARY FOR ENGAGING SAME”.

U.S. Pat. No. 5,739,978, entitled “CARTRIDGE HANDLING SYSTEM WITH MOVING I/O DRIVE”.

U.S. Pat. No. 6,008,964, entitled “CARTRIDGE LIBRARY AND METHOD OF OPERATION THEREOF”.

U.S. patent application Ser. No. 08/970,205, entitled “CARTRIDGE LIBRARY WITH CARTRIDGE LOADER MOUNTED ON MOVEABLE DRIVE ASSEMBLY”.

U.S. patent application Ser. No. 09/121,541, entitled “CARTRIDGE LIBRARY AND METHOD OF OPERATION”.

U.S. Pat. No. 6,005,745 application Ser. No. 09/121,816, entitled “CARTRIDGE LIBRARY WITH ENTRY/EXIT PORT AND METHOD OF OPERATION THEREOF”.

U.S. patent application Ser. No. 09/121,819, entitled “CARTRIDGE LIBRARY AND METHOD OF OPERATION”.

U.S. patent application Ser. No. 09/121,966, entitled “CARTRIDGE MAGAZINE AND LIBRARY EMPLOYING SAME”.

U.S. patent application Ser. No. 09/121,817, entitled “DRIVE CARRIER AND CARTRIDGE LIBRARY EMPLOYING SAME”.

U.S. patent application Ser. No. 09/708,433, entitled “CARTRIDGE LIBRARY”;

U.S. patent application Ser. No. 09/708,432, entitled “CARTRIDGE PICKER ROBOT WITH RIBBON CABLE FOR CARTRIDGE LIBRARY”;

U.S patent application Ser. No. 09/708,451, entitled “ADJUSTABLE MOUNTING FOR BARCODE READER WITH BACKLASH PREVENTION”;

U.S. Design patent application Ser. No. 29/132,408, entitled “CARTRIDGE LIBRARIES”;

U.S. Design patent application Ser. No. 29/132,407, entitled “CARTRIDGE MAGAZINE”.

In an automated tape library, an important task is to align closely the tape handing mechanism (e.g., the robot, the gripper, or the cartridge picker) both to tape cartridge storage cells in the library and to tape drive openings. Such alignment has also been referred to elsewhere and herein as “calibration”. Calibration is important because misalignment can make cartridge picking and placement difficult and error prone.

The prior art attempts to accomplish alignment/calibration are diverse. See, for example, U.S. Pat. No. 6,153,999 to Borrego which attempts to provide dead reckoning in a library by fixing one or more docking targets inside the library in a predetermined orientation with respect to library cells.

Some of the prior art techniques employ an optical sensor or the like. One type of optically-based alignment/calibration system essentially shines a light at a target (the cartridge location or associated with the cartridge location) and senses the location of the reflection. However, aiming a light source and precisely locating a detector to receive the reflection can be problematic. Another type of optically-based alignment/calibration system shines a light through a stationary aperture associated to the cartridge position and senses the location of the transmitted light. Supporting an emitter or detector on the side of the aperture opposite the robot and having it move with the robot is difficult. Some example citations of prior art optical techniques follow.

In U.S. Pat. No. 5,661,287 to Schaefer et al., a rotatable carousel has an “L-shaped” white target. A laser light source and reflectivity sensor are employed to determine coordinates of the L-shaped target, after which the position of removable magazines relative to the L-shaped target are determined in view of known offsets.

In U.S. Pat. No. 6,008,964 to Goodnight et al. and U.S. Pat. No. 6,005,745 to Filkins et al., an automated cartridge has plural cartridge-receiving units which are precisely locatable so that a transport device can accurately move a cartridge therebetween. The cartridge-receiving units have, or accommodate cartridges which have, an uniquely locatable indicia. The indicia is of contrasting reflectivity. A calibration cartridge also bears the uniquely locatable reflective indicia, and is normally stored in a predetermined one of the cartridge storage positions of the library. The calibration cartridge can be moved and inserted in a slot of the tape drive(s) of the library in order to determine exact library coordinates of the tape drive(s). The calibration cartridge has beveled leading edges to facilitate insertion and proper seating into the slot of the tape drive(s).

What is needed, and an object of the present invention, is an accurate and efficient technique for calibrating constituent units of a cartridge library.

### BRIEF SUMMARY OF THE INVENTION

An automated cartridge library has a calibration cartridge which includes a radiation (e.g., optical) source, as well as a frame which accommodates a cartridge-receiving unit and a calibration cartridge storage location. The cartridge-receiving unit can be one or both of a media cartridge storage location (e.g., a cell in a cartridge magazine) and a drive which performs at least one of recording and reproducing operations with respect to media in a media cartridge loaded into the drive. A transport device of the library transports the calibration cartridge between the calibration cartridge storage location and the cartridge-receiving unit. The transport device has a radiation detector which can be aligned with the radiation source of the calibration cartridge when the calibration cartridge is in the cartridge-receiving unit.

In operation of the library, the radiation source included in the calibration cartridge is activated. The transport device transports the calibration cartridge from the calibration cartridge storage location to the cartridge-receiving unit. Upon insertion of the calibration cartridge into the calibration cartridge storage location, the transport device is positioned so that the radiation detector carried by the transport device is aligned with radiation emitted from the radiation source of the calibration cartridge. A calibration reference value for the cartridge-receiving unit is determined when the radiation detector is aligned with the radiation source included in the calibration cartridge. The calibration reference value can be, for example, a spatial coordinate of the library.

Activation of the radiation source included in the calibration cartridge can occur in various ways. For example in this regard, activation of the radiation source included in the calibration cartridge can be activated through activation contacts formed in the calibration cartridge storage location, or activated mechanically upon removal of the calibration cartridge from calibration cartridge storage location 40, or remotely. In the former case, the radiation source of the calibration cartridge is remotely activated by an electromagnetic signal from the a calibration cartridge activation unit. In one example embodiment, the calibration cartridge activation unit is mounted on the transport device.

In an example embodiment, the calibration cartridge has a battery for supplying power to the radiation source. The calibration cartridge storage location has battery recharge contact(s) formed therein for recharging the battery of the calibration cartridge when the calibration cartridge is inserted in the calibration cartridge storage location.

In one of its aspects, the invention concerns a calibration cartridge for use in an automated media library. The calibration cartridge includes a calibration cartridge body, as well as the radiation source situated in the calibration cartridge body.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a perspective view, with covering housing removed, of an automated cartridge library according to an example, representative embodiment of the present invention.

FIG. 2 is a front perspective view showing a calibration cartridge according to an embodiment of the invention inserted in its calibration cartridge storage location.

FIG. 3 is an exploded front perspective view of FIG. 2.

FIG. 3A s an exploded front perspective view according to another embodiment.

FIG. 4 is a rear perspective view of a cartridge picker included in the automated cartridge library of FIG. 1.

FIG. 5 is a bottom perspective view of the cartridge picker of FIG. 4, with a bottom housing plate removed.

FIG. 6 is a rear perspective view of cartridge picker and a calibration cartridge storage location with inserted calibration cartridge in the automated cartridge library of FIG. 1.

FIG. 6A is a rear perspective view of cartridge picker and a calibration cartridge storage location with inserted calibration cartridge according to the embodiment of FIG. 3A.

FIG. 7 is a flowchart showing example, basic steps involved in a calibration operation for the automated cartridge library of FIG. 1.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

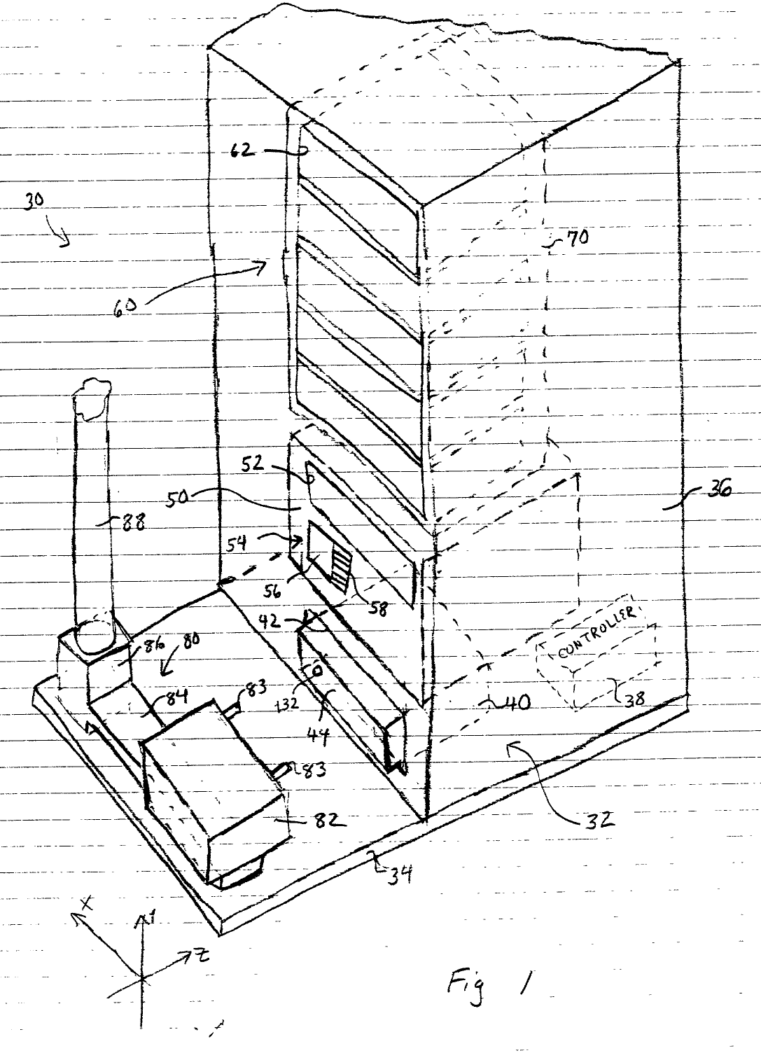

FIG. 1 shows an example, representative automated cartridge library 30 according to an embodiment of the present invention. The automated cartridge library 30 has library frame 32 which includes library floor 34 and library rear frame subsection 36. An unillustrated library cover has been removed in FIG. 1 to expose library frame 32. A controller 38 is shown generically in box form as situated in library rear frame subsection 36 by way of example to represent various apparatus (e.g., processor, circuit cards) for electronic processing and logical operations performed by automated cartridge library 30.

The library rear frame subsection 36 accommodates cartridge-receiving units and a calibration cartridge storage location 40. The cartridge-receiving units include both a tape drive unit 50 and a media cartridge storage section 60. The tape drive unit 50 performs recording and reproducing operations with respect to media in a media cartridge loaded therein. The tape drive unit 50 includes a cartridge slot 52 through which a media cartridge can be inserted into or removed from the tape drive unit 50. In the illustrated embodiment, a front bezel of the tape drive unit 50 features an instrument panel 54, which can include, e.g., a display section 56 and a push button control section 58.

The media cartridge storage section 60 of automated cartridge library 30 is shown as comprising plural cartridge-receiving units or media cartridge cells 62. The media cartridge cells 62 can be formed as partitioned sections of a structure such as cartridge magazine 70. Alternatively, each cell 62 may be separately (e.g., independently) formed in library rear frame subsection 36. In the embodiment shown in FIG. 1, the cartridge magazine 70 is shown for sake of illustration as comprising five cells 62. However, the number of cells or cartridge-receiving units provided in the automated cartridge library 30 is not significant nor limiting for the present invention.

The calibration cartridge storage location 40 has a mouth or opening 42 sized to accommodate a surrogate cartridge known herein as calibration cartridge 44. Preferably but not necessarily, in library rear frame subsection 36 the calibration cartridge storage location 40, tape drive unit 50, and media cartridge storage section 60 are situated so that cartridges inserted in calibration cartridge storage location 40 and the calibration cartridge inserted in calibration cartridge storage location 40 have their protruding ends aligned in a vertical plane (a plane lying parallel to both the X and Y axes of FIG. 1). The same vertical plane would also include the protruding end of any cartridge being inserted into or just discharged from the tape drive unit 50.

In the automated cartridge library 30 of FIG. 1 it so happens that the media cartridge storage section 60 is provided vertically above the tape drive unit 50, and the tape drive unit 50 is in turn situated above calibration cartridge storage location 40. This respective placement of constituent units of library rear frame subsection 36 is merely exemplary and not restrictive of the present invention.

A cartridge transport system 80 is situated in a front part of library frame 32. The cartridge transport system 80 includes a cartridge gripper or picker 82. The cartridge gripper 82 has a pair of picker fingers 83 provided in spaced apart relation and operable to engage or release cartridges carried by cartridge gripper 82. The cartridge gripper 82 is carried on a vertically transitory bracket 84. The bracket 84 is mounted on cantilever fashion by a sleeve 86. The sleeve 86 has internal bearings and vertically travels (e.g., in the direction of Z axis in FIG. 1) along a guideway sleeve 88.

Although not specifically shown in FIG. 1, it should be understood that the cartridge transport system 80 of the automated cartridge library 30 includes one or more motor(s) and appropriate transmission elements (e.g., belts) for imparting vertical motion to bracket 84 and the cartridge gripper 82 carried thereon, so that the cartridge gripper 82 can be selectively aligned vertically with respect to any one of the media cartridge cells 62, the tape drive unit 50, or the calibration cartridge storage location 40. In addition, in embodiments in which cartridge-receiving units are mounted in library rear frame subsection 36 side by side or otherwise in the sense of axis X, the cartridge transport system 80 can include a motor(s) and transmission elements for moving cartridge gripper 82 along bracket 84 in the sense of the X axis. The cartridge gripper 82 has a motor and apparatus for moving cartridge gripper 82 in the +Z direction toward the cartridge-receiving units and for withdrawing the cartridge gripper 82 in the −Z direction from the cartridge-receiving units.

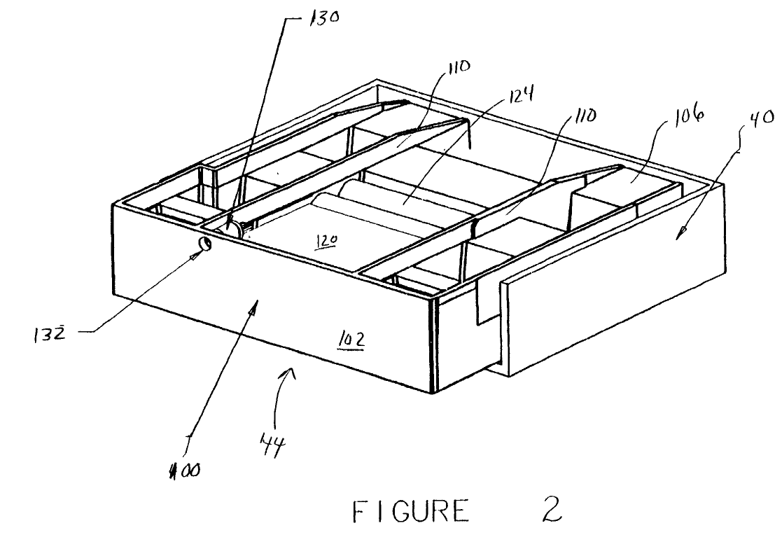

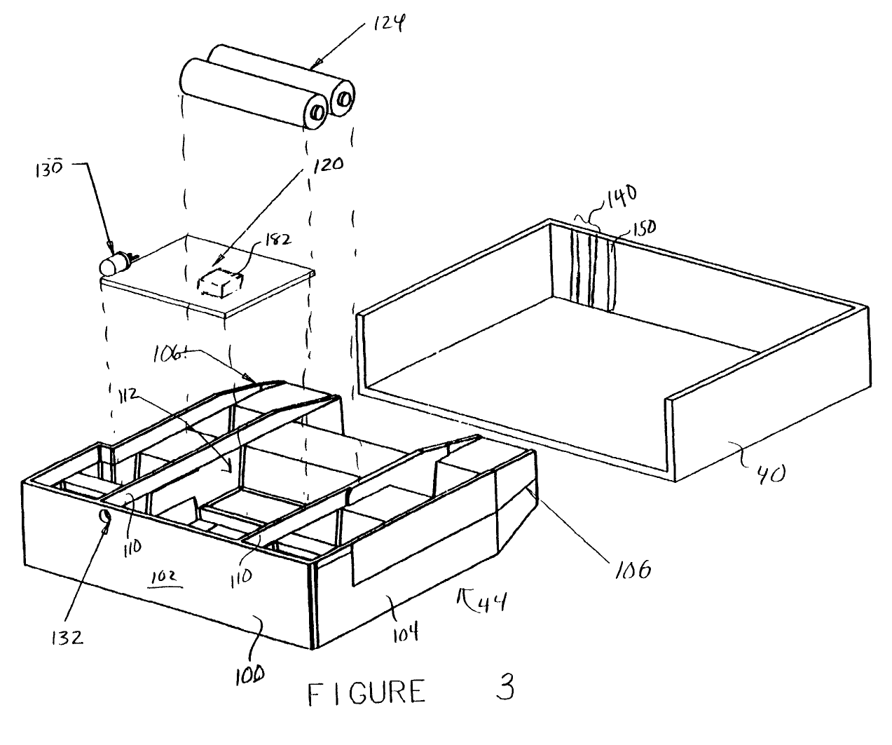

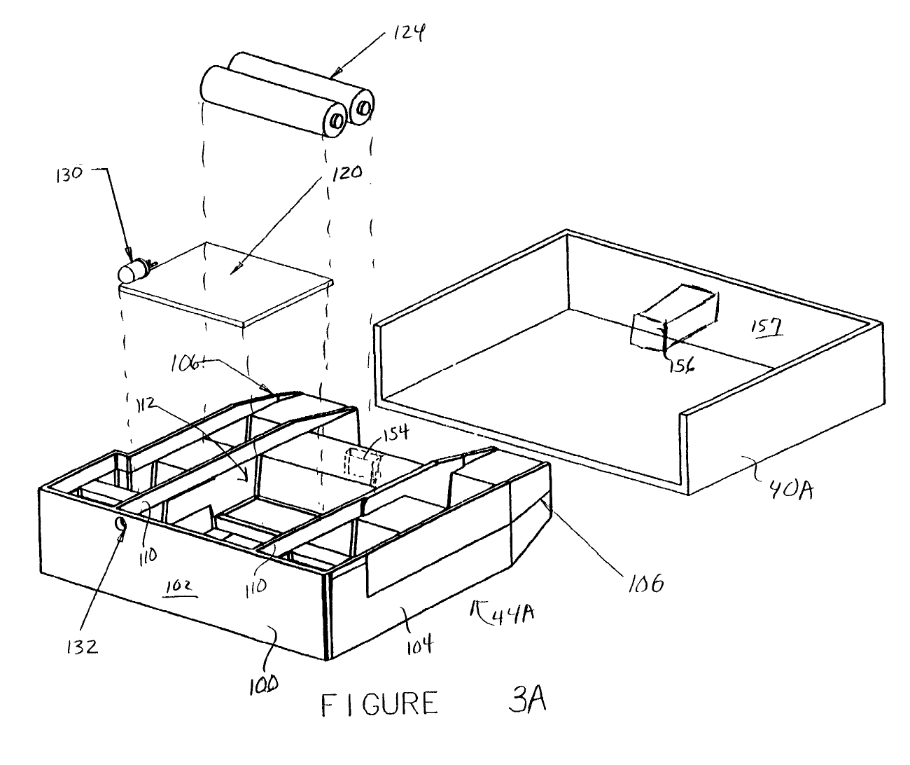

FIG. 2 shows one embodiment of calibration cartridge 44 inserted in its calibration cartridge storage location 40, while FIG. 3 provides an exploded view of calibration cartridge 44 relative to its calibration cartridge storage location 40. For sake of simplicity, calibration cartridge storage location 40 is shown in FIG. 2 and FIG. 3 as essentially comprising, at least in part, a shelf upon which calibration cartridge 44 can be inserted.

As shown in FIG. 3, calibration cartridge 44 has a calibration cartridge body 100. The calibration cartridge body 100 has a front surface 102, as well as two side surfaces 104. At their rearward extremes, the two side surfaces 104 of calibration cartridge body 100 are tapered to provide lead-in prongs 106. The calibration cartridge 44 generally has the same dimensions as a standard media cartridge that is handled by automated cartridge library 30, except that generous lead-ins (chamfers or radii) are provided, e.g., via prongs 106 on the rear thereof to allow the calibration cartridge 44 to be placed in a cartridge-receiving unit even if it is not precisely aligned.

Across its top, calibration cartridge 44 has a pair of braces or ribs 110. Between the ribs 110 and behind front surface 102 a cavity 112 is formed (see FIG. 3). As understood from FIG. 3, the cavity 112 accommodates a circuit card 120 and a pair of batteries 124. The circuit card 120 carries, or has mounted thereto, a radiation source such as optical source 130. The optical source 130, when activated, emits a beam of radiation (e.g., light). The beam of radiation emitted from optical source 130 exits through an alignment aperture 132 formed in front surface 102 of calibration cartridge body 100. The location of alignment aperture 132 (in the sense of the X and Y axes of FIG. 1) relative to the external features that locate the calibration cartridge 44 is held to small tolerances. In some embodiments, the beam of radiation may be from a collimated source (e.g., from a laser).

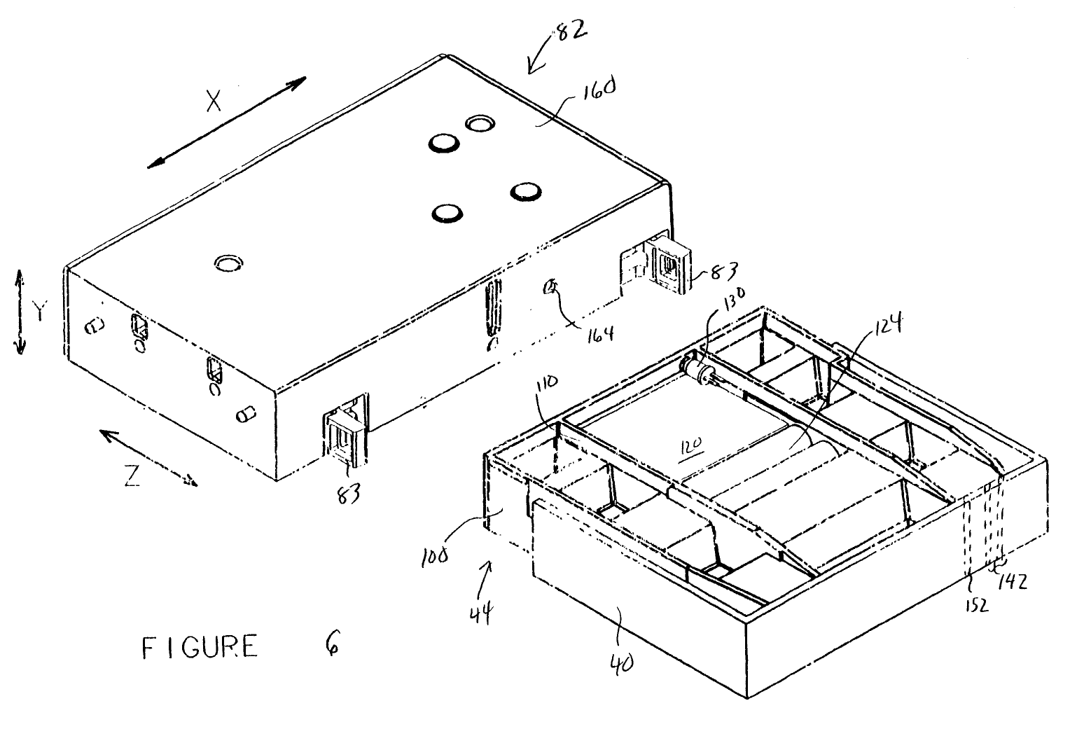

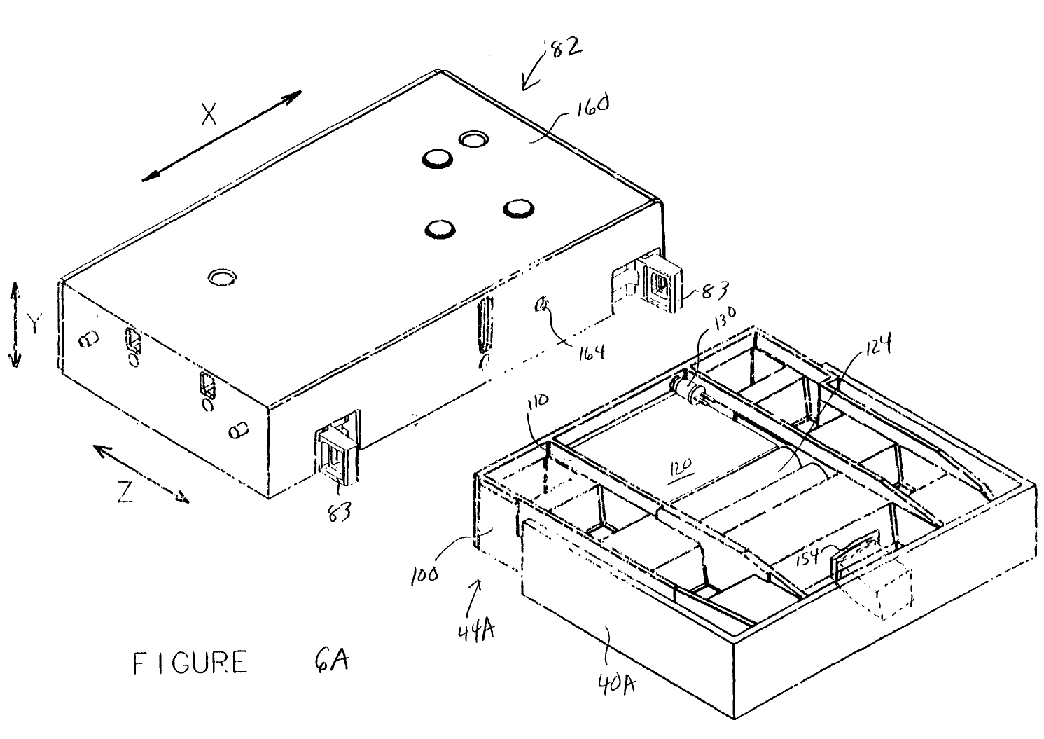

As mentioned above, the example calibration cartridge 44 has one or more batteries 124 for supplying power to the radiation (optical) source 130. As an optional feature, when the battery(ies) 124 are rechargeable, a rear interior wall of calibration cartridge storage location 40 has battery recharge contacts 140 formed therein for recharging the battery(ies) 124 of calibration cartridge 44 when calibration cartridge 44 is inserted in calibration cartridge storage location 40. The battery recharge contacts 140 are electrically connected to an unillustrated battery charging device which is preferably situated within library frame 32. The battery recharge contacts 140 mate with corresponding battery recharge contacts 142 provided on a rear of calibration cartridge body 100, e.g., provided on the rear of lead-in prongs 106 (see FIG. 6). The battery recharge contacts 142 provided on a rear of calibration cartridge body 100 are electrically connected to recharge the pair of batteries 124.

As another aspect of the invention, the optical source 130 of calibration cartridge 44 can be selectively activated in any of several ways. For example in this regard, activation of the optical source 130 included in the calibration cartridge can be activated through activation contacts formed in the calibration cartridge storage location, or activated mechanically upon removal of the calibration cartridge from calibration cartridge storage location 40, or remotely.

In one embodiment illustrated in FIG. 3, a rear interior wall of calibration cartridge storage location 40 also has source activation contact 150 formed thereon. The source activation contact 150 mates with a corresponding source activation contact 152 provided on the rear of calibration cartridge body 100, e.g., on the rear of lead-in prongs 106 (see FIG. 6). The source activation contact 150 of calibration cartridge storage location 40 is connected to carry a source activation signal to optical source 130 from, e.g., controller 38.

In another embodiment illustrated in FIG. 3A and FIG. 6A, removal of the calibration cartridge 44A from calibration cartridge storage location 40A causes activation of optical source 130. In particular, a rear surface of calibration cartridge 44A has a source activation switch 154 provided thereon. A switch actuator 156 protrudes from an interior wall 157 of calibration cartridge storage location 40A at a position to bear against switch 154 when calibration cartridge 44A is inserted in calibration cartridge storage location 40A. So long as the switch actuator 156 bears against source activation switch 154, the optical source 130 remains deactivated. But when calibration cartridge 44A is extracted or removed from calibration cartridge storage location 40A, switch actuator 156 no longer bears against source activation switch 154, with the result that optical source 130 becomes activated and stays activated until calibration cartridge 44A is returned to calibration cartridge storage location 40A. The embodiment illustrated in FIG. 3A and FIG. 6A is particularly beneficial when the batteries 124 are not rechargeable batteries.

The cartridge transport system 80 of the library performs various functions, including transport of media cartridges between the tape drive unit 50 and media cartridge cells 62. In addition, and particularly pertinent to the present invention, the cartridge transport system 80 carries or transports the calibration cartridge 44 between the calibration cartridge storage location 40 and the cartridge-receiving unit(s), e.g., the tape drive unit 50 and media cartridge cells 62.

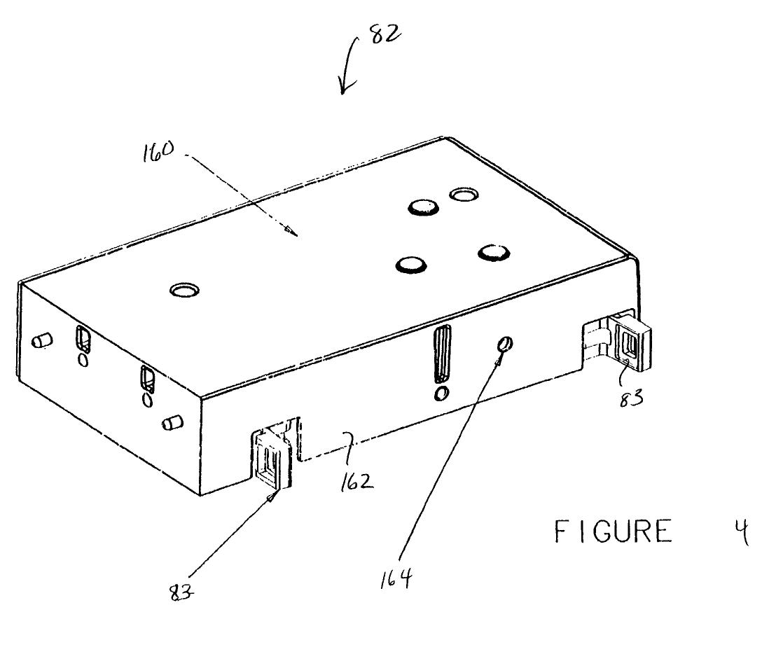

FIG. 4 shows a rear view of the cartridge gripper 82. The cartridge gripper 82 has a gripper top housing 160, which includes a gripper rear wall 162. The pair of gripper or picker fingers 83 extend through apertures or slots provided in gripper rear wall 162.

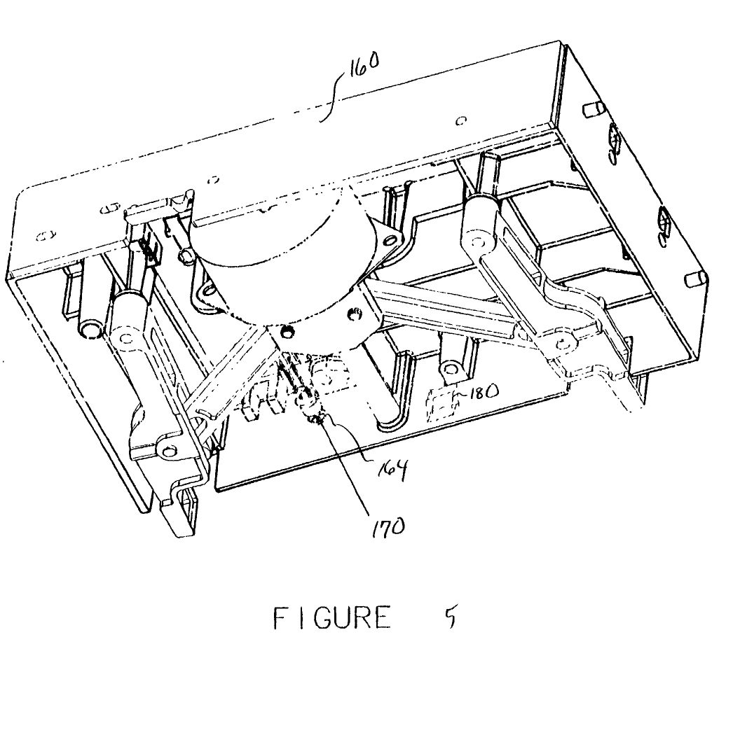

Significant to the present invention is the fact that the gripper rear wall 162 has an detector aperture 164. Behind the detector aperture 164 and within gripper top housing 160 is a radiation detector 170. The radiation detector 170 is sensitive to the wavelength of optical source 130 in calibration cartridge 44. The position of radiation detector 170 within gripper top housing 160 is best seen in FIG. 5, which is a bottom view of cartridge gripper 82 with its unillustrated bottom wall removed. The location of detector aperture 164 (e.g., in terms of the X and Y axes) to features of cartridge gripper 82 that grasp the calibration cartridge 44 (e.g., picker fingers 83) are held to small tolerances.

In other respects, the components of cartridge gripper 82, including elements for actuating the picker fingers 83, are understood from one or more of the following (all of which are incorporated herein by reference): U.S. Pat. No. 6,008,964 to Goodnight et al.; U.S. Pat. No. 6,005,745 to Filkins et al.; U.S. Pat. No. 5,487,579 to Woodruff et al.; and U.S. Pat. No. 5,894,941 to Woodruff.

As explained hereinafter, the radiation detector 170 of cartridge gripper 82 can be aligned with the optical source 130 of the calibration cartridge 44 when the calibration cartridge 44 is in the cartridge-receiving unit (e.g., one of the media cartridge cells 62 or tape drive unit 50), thereby facilitating determination of a calibration reference value for the cartridge-receiving unit and thus calibration of the automated cartridge library 30.

For the aspect of the invention pertaining to remote activation of the optical source 130 mentioned above, the automated cartridge library 30 can also include a calibration cartridge activation unit 180. In one example embodiment, the calibration cartridge activation unit 180 is carried by the cartridge gripper 82. In view of its optional inclusion, the calibration cartridge activation unit 180 is shown in broken lines 30 in FIG. 5. When prompted, e.g., by controller 38, the calibration cartridge activation unit 180 emits an electromagnetic signal which activates optical source 130 of calibration cartridge 44. In particular, the electromagnetic signal (e.g., an IR signal) emitted by calibration cartridge activation unit 180 is sensed by activation sensor 182 in calibration cartridge 44, and upon such sensing the activation sensor 182 turns on optical source 130. In calibration cartridge 44, the activation sensor 182 can optionally be included on circuit card 120, as shown by broken lines in FIG. 3. For this aspect of the invention, in awaiting remote activation the calibration cartridge 44 would be in a standby state powered by the pair of batteries 124.

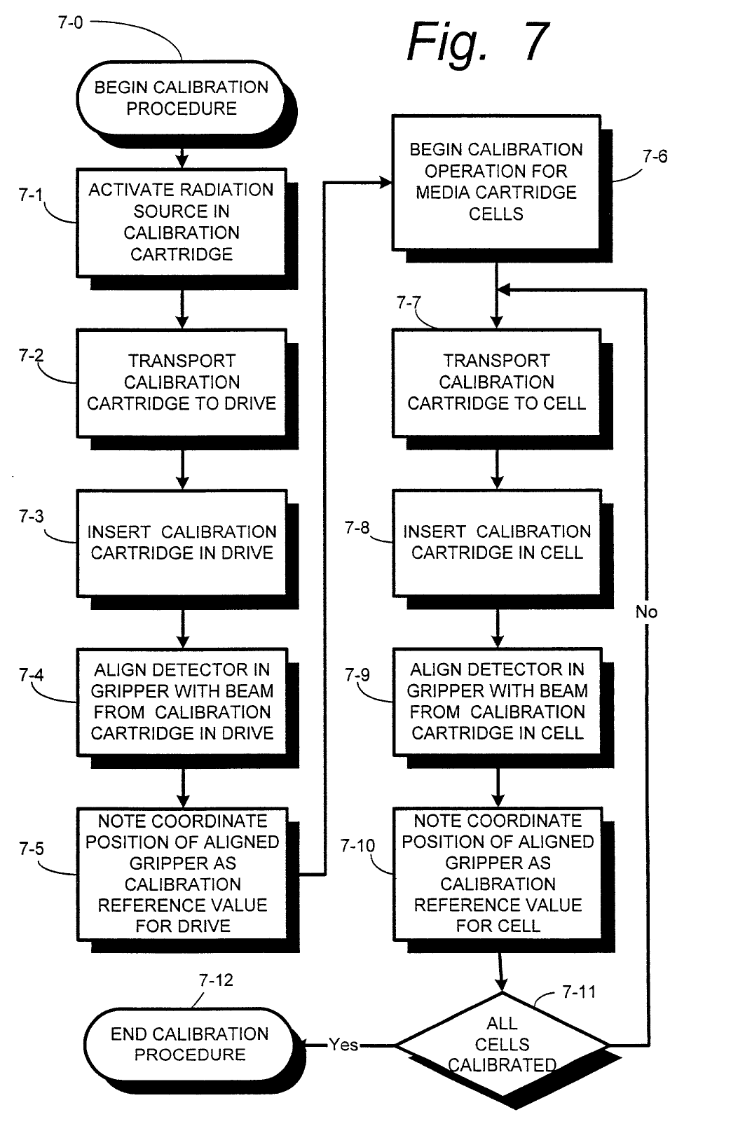

Basic example steps performed in connection with a calibration procedure of automated cartridge library 30 are shown in FIG. 7. Typically the calibration procedure is performed under supervision of controller 38. It should be kept in mind that controller 38 and the operations/steps herein attributed to controller 38 may be performed by diverse processors and logic circuits distributed throughout automated cartridge library 30, and not by a single control unit (although a single controller 38 is show for ease of illustration).

Commencement of the calibration procedure for automated cartridge library 30 is depicted as step 7-0. Commencement usually occurs when the media cartridge cells 62 of automated cartridge library 30 are empty, e.g., prior to actual operation of automated cartridge library 30. Typically at commencement of the calibration procedure the calibration cartridge 44 is situated in its calibration cartridge storage location 40.

As step 7-1, the optical source 130 in calibration cartridge 44 is activated. The activation of optical source 130 can occur in one embodiment by sending a signal from controller 38 to source activation terminal 150 of calibration cartridge storage location 40. As understood from the foregoing, the signal received at source activation terminal 150 is transmitted via source activation terminal 152 on calibration cartridge 44 to optical source 130, so that the optical source 130 becomes activated. In another embodiment, the calibration cartridge activation unit 180 on cartridge gripper 82 is prompted (e.g., by controller 38) to issue an electromagnetic signal. When the electromagnetic signal emanating from calibration cartridge activation unit 180 is sensed by activation sensor 182, the activation sensor 182 turns on optical source 130 in calibration cartridge 44. In the further embodiment of FIG. 3A and FIG. 6A, mere removal of the calibration cartridge 44A from calibration cartridge storage location 40A prompts activation of optical source 130, as explained above. For this embodiment, step 7-1 is included in step 7-2 (discussed below).

As step 7-2, the cartridge gripper 82 is activated to retrieve the calibration cartridge 44 from its calibration cartridge storage location 40. This may involve moving the cartridge gripper 82 in the Y axis direction as shown in FIG. 1, so that the cartridge gripper 82 is at the same altitude as calibration cartridge storage location 40. The cartridge gripper 82 is then operated to move in the Z direction toward the calibration cartridge 44, with the picker fingers 83 of cartridge gripper 82 being opened (e.g., in their spread apart orientation). The picker fingers 83 are then actuated to their closed orientation in order to engage the calibration cartridge 44. The cartridge gripper 82 is then backed away in the −Z direction. The controller 38 causes the cartridge gripper 82 to move along the Y direction to a nominal height of drive 50. Thus, step 7-2 essentially involves transporting the calibration cartridge 44 (with its activated optical source 130) to tape drive unit 50.

As step 7-3, the cartridge gripper 82 inserts the calibration cartridge 44 into the cartridge slot 52 in tape drive unit 50. Such insertion involves the cartridge gripper 82 moving in the +Z direction and placing the calibration cartridge 44 in the cartridge slot 52. The lead-in prongs 106 provided on the rear of calibration cartridge 44 facilitate insertion of the calibration cartridge 44 into tape drive unit 50, even though the placement of calibration cartridge 44 relative to cartridge slot 52 may not yet be precise.

With the calibration cartridge 44 now positioned in the cartridge slot 52 of tape drive 50, the cartridge gripper 82 is slightly backed up (in the −Z direction). As step 7-4, the cartridge gripper 82 is moved iteratively through a pattern of positions in the X-Y plane in an attempt to detect alignment/calibration of the cartridge gripper 82 with tape drive 50. Each of the positions in the pattern in the X-Y plane essentially has an X coordinate and a Y coordinate. The X coordinate can correspond to the number of steps through which a motor is operated to place cartridge gripper 82 at a certain position on the X axis; the Y coordinate can correspond to the number of steps through which a motor is operated to place cartridge gripper 82 at a certain position on the Y axis.

The cartridge gripper 82 is iteratively moved in this fashion until the detector aperture 164 of cartridge gripper 82 is precisely aligned with the activated optical source 130 of calibration cartridge 44. When, in the course of the iterative change of positions, the radiation detector 170 on cartridge gripper 82 detects through its detector aperture 164 the beam emanating from activated optical source 130, the controller 38 knows that dead reckoning between the cartridge gripper 82 and tape drive 50 has been achieved. The stepped position of the cartridge gripper 82 at the time of alignment corresponds to a X-Y coordinate position for tape drive 50 which, as step 7-5, is noted and stored as the calibration reference value for tape drive 50.

With the position of tape drive 50 having been calibrated, step 7-6 depicts the beginning of a calibration subprocedure for the one or more cells 62 which can accommodate media cartridges. The subprocedure for cells comprises steps 7-7 through 7-11, which are executed for each of the cells 62 for which calibration is desired.

As step 7-7, the calibration cartridge 44 is transported by cartridge gripper 82 to a specified one of the cells 62. Step 7-8 involves inserting the calibration cartridge 44 into that specified cell. Step 7-7 and step 7-8 are akin to step 7-2 and 7-3, respectively, it being understood that the cartridge-receiving unit now in question is a cartridge cell rather than the tape drive 50. Considerations involved in the foregoing description of transport and insertion of the calibration cartridge 44 into tape drive 50 equally apply to the cells 62, including moving the cartridge gripper 82 to a nominal height (along the Y axis) of the specified cell, and using the lead-in prongs 106 provided on the rear of calibration cartridge 44 facilitate insertion of the calibration cartridge 44 into the specified cell (despite the alignment not yet being precise).

As step 7-9 the cartridge gripper 82 is moved through another pattern of positions in the X-Y plane in like manner as step 7-4, seeking alignment of detector aperture 164 formed in cartridge gripper 82 (and hence of radiation detector. 170) with optical source 130 of calibration cartridge 44 (calibration cartridge 44 now being activated and positioned in the specified cell 62). At step 7-10 the X-Y coordinate position of the successful alignment is noted and stored as the calibration reference value for the specified cell.

Upon calibration of a cell position in the manner just described, the controller 38 checks at step 7-11 to determine whether all cells have been calibrated. If other cells have yet to have their position calibrated, the calibration subprocedure comprising step, 7-7 through 7-10 is performed for such remaining cells. Of course, this involves moving the cartridge gripper 82 (engaging the calibration cartridge 44) to the nominal location of the cell, inserting the calibration cartridge 44 into the cell, and then seeking the alignment of the radiation detector 170 and optical source 130 in the manner previously described, noting the X,Y coordinate of the cell upon successful alignment. After all cells have been positionally aligned in the manner aforedescribed, the calibration procedure can terminate (as indicated by step 7-12). Termination includes returning the calibration cartridge 44 to the calibration cartridge storage location 40, and turning off (deactivating) the optical source 130 of calibration cartridge 44.

In the scenario shown in FIG. 7, the physical position of tape drive unit 50 is calibrated prior to calibration of the media cartridge cells 62. However, it should be understood that this order is not important, e.g., the converse of the order can occur.

Further, it may also be desired to calibrate the position of the calibration cartridge storage location 40. Calibration of the position of calibration cartridge storage location 40 can occur in analogous manner as the calibration of the cells and tape drive unit 50 as above described. The calibration of the calibration cartridge storage location 40 assumes that an embodiment is utilized that does not require removal of calibration cartridge 44 from the calibration cartridge storage location 40 in order to activate the optical source 130.

Moreover, it should be understood that, in a differing scenario involving an embodiment that has a calibration cartridge activation unit 180, the activation of optical source 130 of calibration cartridge 44 can be timed differently. For example, rather than activate optical source 130 at the beginning of the calibration procedure and keep optical source 130 activate throughout the entire calibration procedure, the calibration cartridge activation unit 180 can activate the optical source 130 just after the calibration cartridge 44 has been inserted into a cartridge-receiving unit, and then deactivate optical source 130 after the alignment for that particular cartridge-receiving unit has been completed. After the calibration cartridge 44 is inserted into another cartridge-receiving unit the optical source 130 can again be activated by calibration cartridge activation unit 180, and similarly deactivated after alignment is accomplished. Thus, in the embodiment having a calibration cartridge activation unit 180, activation of optical source 130 can occur on a per cartridge-receiving unit basis, rather than keeping optical source 130 activated throughout the duration of the calibration procedure.

An example drive suitable for use with the automated cartridge library 30 of the present invention is the Exabyte® Mammoth family of helical scan tape drives and predecessors thereof, such as the Exabyte® 8500 series of helical scan drives. However, it should be understood that the automated cartridge library 30 of the present invention is not limited to any particular type of drive employment, or to any particular media size, format, or media material.

In the FIG. 1 embodiment, the media cartridge cells 62 have been illustrated as being formed by cartridge magazine 70, with a single and stationary cartridge magazine 70 being provided in library rear frame subsection 36. The number of cells 62, how the cells 62 are defined (e.g., by cartridge magazine or not), the geometry of the presentation of media cartridge cells 62 to cartridge gripper 82, and the mounting of the cells/magazine (e.g., stationary or not) are features which can vary among differing embodiments. For example, the library rear frame subsection 36 may comprise a plate/spit or geometrical surface which rotates to present differing cells/magazines to cartridge gripper 82. See, for examples in this regard, U.S. Pat. No. 5,768,047 which shows a rotatable spit upon which magazines are mounted, and U.S. Pat. No. 5,607,275 which shows a rotating drum upon which magazines are mounted (both U.S. Pat. Nos. 5,768,047 and 5,607,275 being incorporated by reference herein).

The present invention provides an efficient way of locating an aperture 132 in the calibration cartridge 44 and aperture 164 in cartridge gripper 82 to relevant features on each, thereby reducing the uncertainty of location. Moreover, preferably the apertures such as aperture 132 in the calibration cartridge 44 and aperture 164 in cartridge gripper 82 are rectangular instead of round. Rectangular apertures permit discernment of vertical and horizontal edges of the aperture, and thus an interpolation to find the middle of the aperture. In this way, the accuracy does not depend on the size of the apertures (e.g., on the radius of round apertures).

The present invention avoids any uncertainty involved in aiming an emitter or predicting the position of reflected light from a target. Moreover, the difficulty inherent in supporting an emitter or detector by the robot (e.g., cartridge gripper 82) on the opposite side of a fixed aperture is avoided. Nor is there any need to have an optical target (either reflective or transmissive) for each storage cell matrix or drive opening. Such optical targets take up space that can otherwise be used for cartridge storage.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. For example, the invention is not limited by having any particular internal construction of the calibration cartridge 44 (e.g., does not require ribs 110 or circuit card 120 for the mounting of electronics).

What is claimed is:

1. An automated media library comprising:
a calibration cartridge, the calibration cartridge having a radiation source
a library frame which accommodates a cartridge-receiving unit and a calibration cartridge storage location;
a transport device which transports the calibration cartridge between the calibration cartridge storage location and the cartridge-receiving unit, the transport device having a radiation detector which can be aligned with the radiation source of the calibration cartridge when the calibration cartridge is in the cartridge-receiving unit;
a controller which determines a calibration reference value for the cartridge-receiving unit when the radiation detector is aligned with the radiation source of the calibration cartridge when the calibration cartridge is in the cartridge-receiving unit.

2. The apparatus of claim 1, wherein the cartridge-receiving unit is one of a media cartridge storage location provided on the library frame and a drive which performs at least one of recording and reproducing operations with respect to media in a media cartridge loaded into the drive.

3. The apparatus of claim 1, wherein the calibration reference value is a spatial coordinate of the library.

4. The apparatus of claim 1, wherein the radiation source is an optical source and the radiation detector is an optical detector.

5. The apparatus of claim 1, wherein the calibration cartridge further comprises a battery for supplying power to the radiation source.

6. The apparatus of claim 5, wherein the calibration cartridge storage location has battery recharge contacts formed therein for recharging the battery of the calibration cartridge when the calibration cartridge is inserted in the calibration cartridge storage location.

7. The apparatus of claim 1, wherein the calibration cartridge storage location has a calibration cartridge activation contact formed therein for selectively activating the radiation source of the calibration cartridge.

8. The apparatus of claim 1, wherein the radiation source of the calibration cartridge is remotely activated.

9. The apparatus of claim 8, wherein the radiation source of the calibration cartridge is remotely activated by an electromagnetic signal from the a calibration cartridge activation unit.

10. The apparatus of claim 9, wherein the calibration cartridge activation unit is mounted on the transport device.

11. The apparatus of claim 1, wherein the calibration cartridge has a source activation switch provided thereon which is actuated to deactivate the radiation source so long as the calibration cartridge remains in the calibration cartridge storage location, but which is actuated to activate the radiation source when the calibration cartridge is removed from the calibration cartridge storage location.

12. For use in an automated cartridge library having a frame which accommodates a cartridge-receiving unit and a calibration cartridge storage location; a method comprising:
(1) activating a radiation source included in a calibration cartridge;
(2) using a transport device to transport the calibration cartridge from the calibration cartridge storage location to the cartridge-receiving unit;
(3) aligning a radiation detector carried by the transport device with radiation emitted from the radiation source of the calibration cartridge when the calibration cartridge is in the cartridge-receiving unit;
(4) determining a calibration reference value for the cartridge-receiving unit when the radiation detector upon the aligning of step (3).

13. The method of claim 12, wherein the cartridge-receiving unit is a media cartridge storage location provided on the library frame, and wherein in step (4) the calibration reference value for the media cartridge storage location is determined.

14. The method of claim 12, wherein the cartridge-receiving unit is a drive which performs at least one of recording and reproducing operations with respect to media in a media cartridge loaded into the drive, and wherein in step (4) the calibration reference value for the drive is determined.

15. The method of claim 12, wherein the calibration reference value is a spatial coordinate of the library.

16. The method of claim 12, wherein step (1) involves activating an optical source as the radiation source included in the calibration cartridge.

17. The method of claim 12, further comprising using a battery to supply power to the radiation source.

18. The method of claim 17, wherein comprising recharging the battery using a battery recharge contact formed in the calibration cartridge storage location when the calibration cartridge is inserted in the calibration cartridge storage location.

19. The method of claim 12, wherein step (1) is selectively performed by utilizing a calibration cartridge activation contact formed in the calibration cartridge storage location.

20. The method of claim 12, wherein the activating of step (1) is remotely initiated.

21. The method of claim 20, further comprising remotely activating the radiation source of the calibration cartridge by emitting an electromagnetic signal from a calibration cartridge activation unit.

22. The method of claim 20, further comprising carrying the calibration cartridge activation on the transport device.

23. The method of claim 12, further comprising activating the radiation source by physical removal of the calibration cartridge from the calibration cartridge storage location.

24. A calibration cartridge for use in an automated media library comprising:
a calibration cartridge body;
a radiation source situated in the calibration cartridge body.

25. The apparatus of claim 24, wherein the radiation source is an optical source.

26. The apparatus of claim 24, further comprising a battery for supplying power to the radiation source.

27. The apparatus of claim 24, wherein the calibration cartridge has a battery recharge contact formed thereon for supply a recharge voltage for recharging the battery of the calibration cartridge when the calibration cartridge is inserted in a calibration cartridge storage location of the library.

28. The apparatus of claim 24, wherein the calibration cartridge has a calibration cartridge activation contact formed thereon for receiving a signal for selectively activating the radiation source of the calibration cartridge.

29. The apparatus of claim 24, wherein the radiation source of the calibration cartridge is remotely activated, and wherein the calibration cartridge further comprises an actuation receiver which receives an electromagnetic signal for remotely activating the radiation source of the calibration cartridge.

30. The apparatus of claim 24, wherein the calibration cartridge has a source activation switch provided thereon which is actuated to deactivate the radiation source so long as the calibration cartridge remains in the calibration cartridge storage location, but which is actuated to activate the radiation source when the calibration cartridge is removed from the calibration cartridge storage location.
